(19) United States
(12) Patent Application Publication
(10) Pub. No.: US 2013/0206442 A1
(43) Pub. Date: Aug. 15, 2013

(54) HEAD STRUCTURE OF PNEUMATIC TOOL

(71) Applicant: Master Air Tool Co., Ltd., (US)

(72) Inventor: Nan-Hsin WANG, Taichung (TW)

(73) Assignee: MASTER AIR TOOL CO., LTD., Taichung (TW)

(21) Appl. No.: 13/658,532

(22) Filed: Oct. 23, 2012

(30) Foreign Application Priority Data
Feb. 10, 2012 (TW) 101104394

(51) Int. Cl. B25F 5/00

(52) U.S. Cl. 173/216

(57) ABSTRACT

A head structure of a pneumatic tool has an accommodation room in a pneumatic tool body. A driving gear and a transmission unit are pivoted in the accommodation room. The transmission unit includes a gear member having a transmission gear to mesh with the driving gear. The rear end of the gear member is provided with a gear rod. A bearing fitted on the gear rod is limited to a first limit portion at the distal end of the transmission gear. The gear rod is connected with a connection member which has a second connection portion to engage with the first connection portion. The connection member has a second limit portion adapted to limit another side of the bearing. The limit member is secured to the distal end of the accommodation room. The limit member is adapted to limit the bearing in the accommodation room.

The current application claims a foreign priority to the patent application of Taiwan No. 101104394 filed on Feb. 10, 2012.

### BACKGROUND OF THE INVENTION

1. Field of the Invention

The present invention relates to a head structure of a pneumatic tool.

2. Description of the Prior Art

FIG. 1 is an exploded view of a conventional pneumatic tool head. A pneumatic tool body 10 comprises a gear (not shown) which is located in a front end of a housing 12. A transmission unit 20 is connected in the housing 12. The transmission unit 20 comprises a transmission rod 21, a gear 22 and a bearing 23. The transmission rod 21 has a slot 211 on a side wall thereof. The transmission rod 21 has a connection portion 212 which is exposed out of the housing 12. The bearing 23 is first fitted on the transmission rod 21, and then the gear 22 is assembled at the distal end of the transmission rod 21. The gear 22 has a slot 221 on an inner wall thereof. A key 24 is provided between the slot 211 of the transmission rod 21 and the slot 221 of the gear 22 to limit and secure the gear 22 and the transmission rod 21. The gear 22 meshes with the gear of the pneumatic tool body 10 to drive the transmission rod 21 so as to turn the tool on the transmission rod 21. When the transmission unit 20 is assembled, the transmission rod 21 and the gear 22 are forced to be secured. The connection is not easy and it needs greater space for connection, so the housing 12 is larger in size for assembly. When the transmission unit 20 is turned, there will be a gap between the slots 211, 221 and the key 24. The gap will cause a hit between the transmission rod 21 and the gear 22 to cause a noise during use and to damage the parts easily. Accordingly, the inventor of the present invention has devoted himself based on his many years of practical experiences to solve these problems.

### SUMMARY OF THE INVENTION

The primary object of the present invention is to provide a head structure of a pneumatic tool. The head structure can be assembled with ease and won't be damaged and the parts are small in size. The present invention comprises a pneumatic tool body, a transmission unit and a limit member.

The pneumatic body has an accommodation room at a front end thereof. The pneumatic tool body comprises a driving gear which is pivotally connected in the accommodation room. The transmission unit is pivotally connected in the accommodation room. The transmission unit comprises a gear member, a connection member and a bearing. The gear member comprises a transmission gear at one end thereof relative to the driving gear. The transmission gear has a first limit portion at a rear end thereof. The rear end of the first limit portion is provided with a gear rod. The gear rod has a first connection portion at a distal end thereof. The bearing is fitted on the gear rod. One side of the bearing is limited to the first limit portion. The connection member has a second connection portion. The second connection portion is engaged with the first connection portion. The connection member has a second limit portion. The second limit portion is adapted to limit another side of the bearing. The limit member has a central through hole. The limit member is secured to a distal end of the accommodation room. The limit member is adapted to limit the bearing in the accommodation room. Through the gear member and the connection member to limit the bearing, the connection is easy and there is no gap. The space occupied by the parts can be reduced so as to reduce the size of the accommodation room.

### BRIEF DESCRIPTION OF THE DRAWINGS

FIG. 1 is an exploded view of a conventional pneumatic tool head;

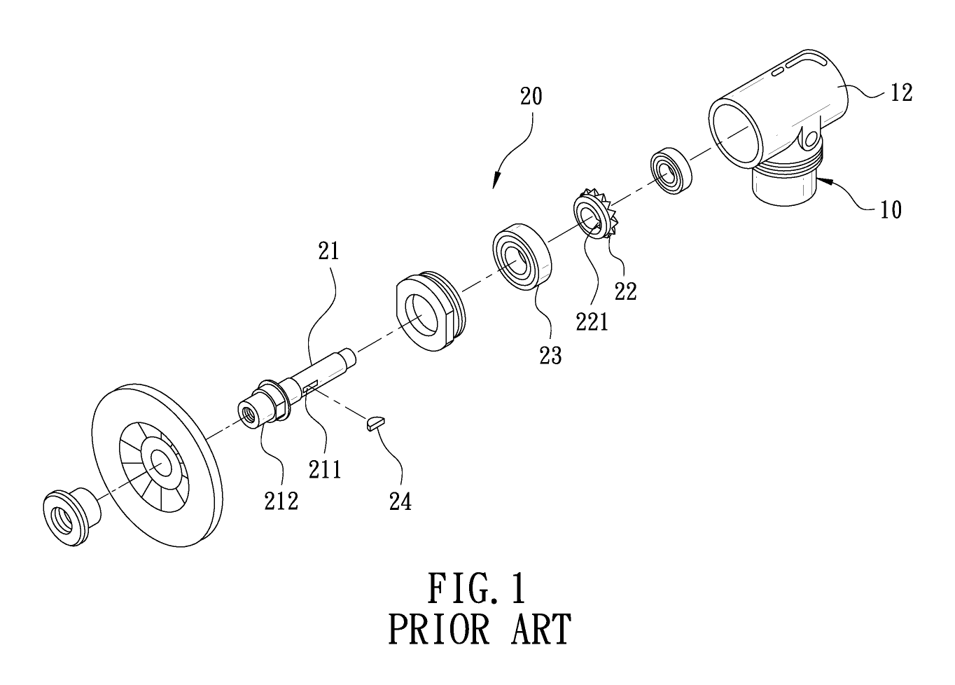

FIG. 2 is an exploded view according to a first embodiment of the present invention;

FIG. 3 is a sectional view according to the first embodiment of the present invention;

FIG. 4 is a sectional view according to a second embodiment of the present invention;

FIG. 5 is a sectional view according to a third embodiment of the present invention; and

FIG. 6 is a sectional view according to a fourth embodiment of the present invention.

### DETAILED DESCRIPTION OF THE PREFERRED EMBODIMENTS

Embodiments of the present invention will now be described, by way of example only, with reference to the accompanying drawings.

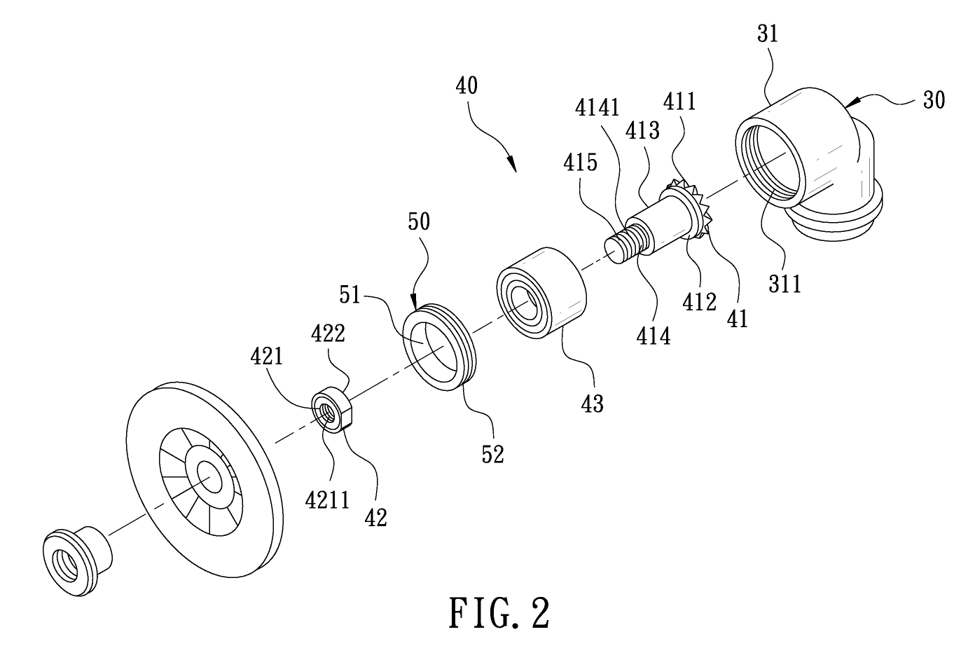

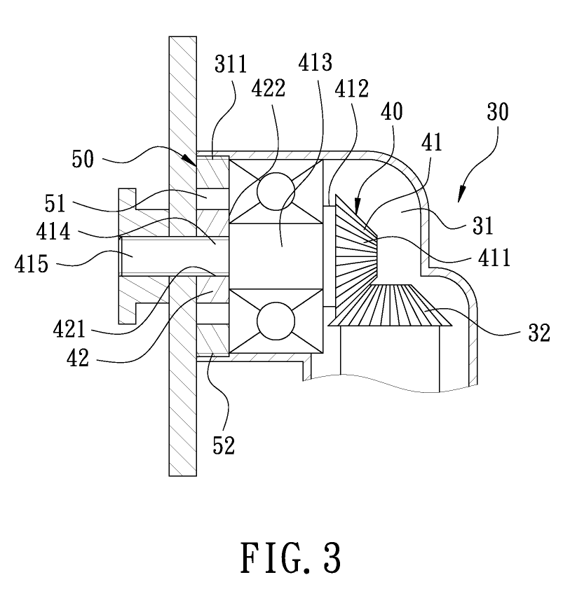

FIG. 2 is an exploded view according to a first embodiment of the present invention. FIG. 3 is a side view according to the first embodiment of the present invention. The pneumatic tool of the present invention comprises a pneumatic tool body 30, a transmission unit 40, and a limit member 50.

The pneumatic tool body 30 has an accommodation room 31 at a front end thereof. The accommodation room 31 has inner threads 311 on a distal end thereof. The pneumatic tool body 30 comprises a driving gear 32 which is pivotally connected in the accommodation room 31. The pneumatic tool may be a pneumatic grinder or a pneumatic polisher.

The transmission unit 40 is pivotally connected in the accommodation room 31. The transmission unit 40 comprises a gear member 41, a connection member 42 and a bearing 43. The gear member 41 comprises a transmission gear 411 at one end thereof relative to the driving gear 32. The transmission gear 411 has a first limit portion 412 at a rear end thereof. The rear end of the first limit portion 412 is provided with a gear rod 413. The gear rod 413 has a first connection portion 414 at a distal end thereof. The first connection portion 414 is outer threads 4141. The first connection portion 414 has a connection rod 415 at a distal end thereof. The bearing 43 is fitted on the gear rod 413. One side of the bearing 43 is limited to the first limit portion 412. The connection member 42 has a second connection portion 421. The second connection portion 421 of the connection member 42 is a threaded trough 4211. The threaded trough 4211 is engaged with the outer threads 4141. One side of the connection member 42 has a second limit portion 422. The first limit portion 412 and the second limit portion 422 are adapted to limit the bearing 43.

The limit member 50 has a central through hole 51 for insertion of the connection rod 415. The limit member 50 has outer threads 52 on an outer wall thereof. The outer threads 52 are engaged with the inner threads 311 of the accommodation room 31, so that the limit member 50 is secured to the distal end of the accommodation room 31. The limit member 50 is adapted to limit the bearing 43 at a predetermined position in the accommodation room 31.

Referring to FIG. 2 and FIG. 3, when the transmission unit 40 is assembled, the connection member 42 is first screwed to the gear member 41 and the bearing 43 is secured. The limit member 50 presses the bearing 43 to limit the bearing 43 at the predetermined position in the accommodation room 31. The driving gear 31 drives the transmission gear 411 to turn the connection rod 415 so as to bring rotation of the tool. This connection way just uses the gear member 41 and the connection member 42 to connect with each other. The connection way is simple, without using a tightening way, to enhance the precision of the connection. The transmission gear 411 of the gear member 41 and the gear rod 413 are integral, so there is no gap, noise or damage when rotated. The parts in accommodation room 31 are reduced.

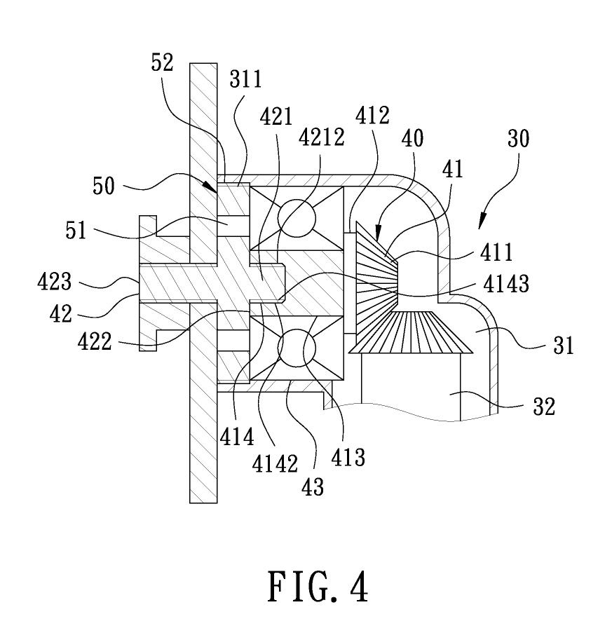

FIG. 4 is a sectional view according to a second embodiment of the present invention, which is substantially similar to the first embodiment with the exception described hereinafter. The first connection portion 414 is a trough 4142 formed at the distal end of the gear rod 413. The trough 4142 has inner threads 4143. The second connection portion 421 is a threaded rod 4212. The threaded rod 4212 of the second connection portion 421 is screwed to the inner threads 4143 of the trough 4142 of the first connection portion 414. The connection member 42 has a connection rod 423 at another side opposite to the second connection portion 421. The connection rod 423 is adapted to connect the tool.

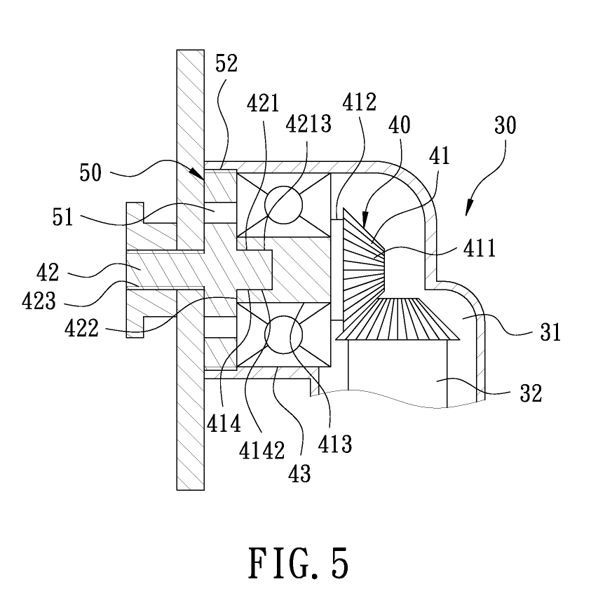

FIG. 5 is a sectional view according to a third embodiment of the present invention, which is substantially similar to the first embodiment with the exception described hereinafter. The first connection portion 414 is a trough 4142. The second connection portion 421 is a tightening rod 4213 corresponding to the trough 414. The diameter of the tightening rod 4213 is greater than the diameter of the trough 4142. The tightening rod 4123 is forced to engage with the trough 4142. The connection member 42 has a connection rod 423 at another side opposite to the second connection portion 421. The connection rod 423 is inserted through the through hole 51 and exposed out of the accommodation room 31.

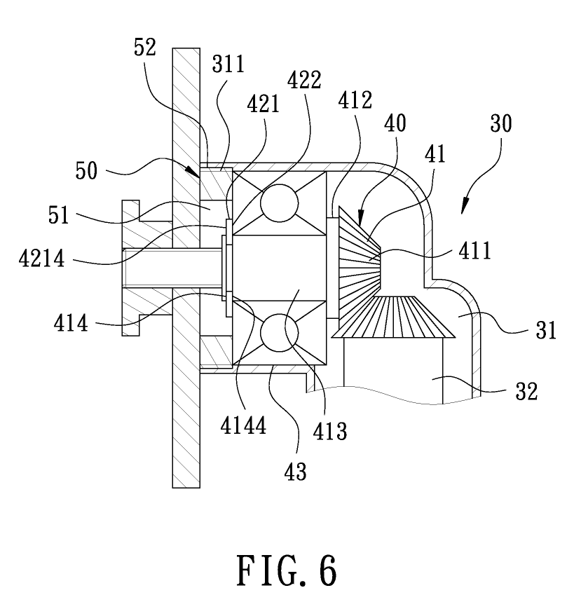

FIG. 6 is a sectional view according to a fourth embodiment of the present invention, which is substantially similar to the first embodiment with the exception described hereinafter. The first connection portion 414 is an annular groove 4144 formed at the distal end of the gear rod 413. The second connection portion 421 is a C-shaped buckle 4214. When the connection member 42 is fitted on the gear rod 413, the C-shaped buckle 4214 is confined in the annular groove 4144, so that the connection member 42 is confined on the gear rod 413. The distal end of the gear rod 413 is provided with a connection rod 415. The connection rod 415 is inserted through the through hole 51 and exposed out of the accommodation room 31.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A head structure of a pneumatic tool, comprising:
a pneumatic tool body, the pneumatic body having an accommodation room at a front end thereof, the pneumatic tool body comprising a driving gear which is pivotally connected in the accommodation room;
a transmission unit, the transmission unit being pivotally connected in the accommodation room, the transmission unit comprising a gear member, a connection member and a bearing, the gear member comprising a transmission gear at one end thereof relative to the driving gear, the transmission gear having a first limit portion at a rear end thereof, a rear end of the first limit portion being provided with a gear rod, the gear rod having a first connection portion at a distal end thereof, the bearing being fitted on the gear rod, one side of the bearing being limited to the first limit portion, the connection member having a second connection portion, the second connection portion being connected with the first connection portion, the connection member having a second limit portion, the second limit portion being adapted to limit another side of the bearing; and
a limit member, the limit member having a central through hole, the limit member being secured to a distal end of the accommodation room, the limit member being adapted to limit the bearing in the accommodation room.

2. The head structure of a pneumatic tool as claimed in claim 1, wherein the first connection portion is a trough, the trough having inner threads, the second connection portion being a threaded rod relative to the trough, the threaded rod being screwed to the trough, the connection member having a connection rod at another side opposite to the second connection portion, the connection rod being inserted through the through hole and exposed out of the accommodation room.

3. The head structure of a pneumatic tool as claimed in claim 1, wherein the first connection portion is outer threads formed at the distal end of the gear rod, the second connection portion of the connection member being a threaded trough, the threaded trough being engaged with the outer threads, the distal end of the gear rod being provided with a connection rod, the connection rod being inserted through the through hole and exposed out of the accommodation room.

4. The head structure of a pneumatic tool as claimed in claim 1, wherein the first connection portion is a trough, the second connection portion being a tightening rod corresponding to the trough, the tightening rod being forced to engage with the trough, the connection member having a connection rod at another side opposite to the second connection portion, the connection rod being inserted through the through hole and exposed out of the accommodation room.

5. The head structure of a pneumatic tool as claimed in claim 1, wherein the first connection portion is an annular groove formed at the distal end of the gear rod, the second connection portion being a C-shaped buckle, when the connection member is fitted on the gear rod, the C-shaped buckle being confined in the annular groove, the distal end of the gear rod being provided with a connection rod, the connection rod being inserted through the through hole and exposed out of the accommodation room.

6. The head structure of a pneumatic tool as claimed in claim 1, wherein the bearing is a dual-line ball bearing.

7. The head structure of a pneumatic tool as claimed in claim 1, wherein the accommodation room has inner threads on a distal end thereof, the limit member having outer threads on an outer wall thereof, the limit member being screwed to the distal end of the accommodation room.

8. The head structure of a pneumatic tool as claimed in claim 1, wherein the pneumatic tool is a pneumatic grinder.

9. The head structure of a pneumatic tool as claimed in claim 1, wherein the pneumatic tool is a pneumatic polisher.
